(19) United States
(12) Patent Application Publication
(10) Pub. No.: US 2002/0094367 A1
(43) Pub. Date: Jul. 18, 2002

(54) Dough composition

(75) Inventors: Claus Crone Fuglsang, Niva (DK); Thomas Honger Callisen, Frederiksberg C (DK); Gitte Budolfsen, Frederiksberg (DK)

Correspondence Address: NOVOZYMES NORTH AMERICA, INC., C/O NOVO NORDISK OF NORTH AMERICA, INC., 405 LEXINGTON AVENUE, SUITE 6400, NEW YORK, NY, 10174, US

(73) Assignee: Novozymes A/S, Bagsvaerd (DK)

(21) Appl. No.: 09/948,265

(22) Filed: Sep. 7, 2001

Related U.S. Application Data
(60) Provisional application No. 60/232,471, filed on Sep. 13, 2000.

(30) Foreign Application Priority Data
Sep. 8, 2000 (DK) PA 2000 01339

(51) Int. Cl. A21D 2/00

(52) U.S. Cl. 426/549; 426/94; 426/61

(57) ABSTRACT

The present invention relates to a composition comprising i) an effective amount of one or more enzyme(s) encapsulated or coated by a lipid substance, wherein said lipid substance a) provides, at a temperature of less than 25° C., a barrier, which inhibits release of said enzyme(s) to the surrounding dough, and b) undergoes a phase transition in the temperature range from 25° C. to 60° C. to release said enzyme(s), and ii) flour and any additional, conventional dough ingredients, to methods for preparing said dough composition, to the use of one or more lipid-encapsulated or lipid-coated enzyme(s) in a dough composition, to a method for improving one or more properties of a dough, to a method for preparing a baked product, and to a dough and/or a baked product produced thereby.

### CROSS-REFERENCE TO RELATED APPLICATIONS

This application claims, under 35 U.S.C. 119, priority of Danish application no. PA 2000 01339, filed Sep. 8, 2000, and the benefit of U.S. provisional application No. 60/232,471, filed Sep. 13, 2000, the contents of which are fully incorporated herein by reference.

### FIELD OF THE INVENTION

The present invention relates to a dough composition comprising one or more lipid-encapsulated or lipid-coated enzyme(s), methods for preparing said dough composition, a use of one or more lipid-encapsulated or lipid-coated enzyme(s) in said dough composition, a method for improving one or more properties of a dough, a method for preparing a baked product, and a dough and/or a baked product produced thereby.

### DESCRIPTION OF THE RELATED ART

The strength of a dough is an important aspect of baking for both small-scale and large-scale applications. A strong dough has a greater tolerance of mixing time, proofing time, and mechanical vibrations during dough transport, whereas a weak dough is less tolerant to these treatments. A strong dough with superior rheological and handling properties results from flour containing a strong gluten network. Flour with a low protein content or a poor gluten quality results in a weak dough.

Dough “conditioners” are well known in the baking industry. The addition of conditioners to bread dough has resulted in improved machinability of the dough and improved texture, volume, flavour, and freshness (anti-staling) of the bread. Nonspecific oxidants, such as iodates, peroxides, ascorbic acid, potassium bromate and azodicarbonamide have a gluten strengthening effect. It has been suggested that these conditioners induce the formation of interprotein bonds which strengthen the gluten and thereby the dough. However, the use of several of the currently available chemical oxidising agents has been met with consumer resistance or is not permitted by regulatory agencies.

The use of enzymes as dough conditioners has been considered as an alternative to the chemical conditioners. A number of enzymes have been used recently as dough and/or bread improving agents, in particular enzymes that act on components present in large amounts in the dough. Examples of such enzymes are found within the groups of amylases, proteases, glucose oxidases, trans-glutaminases and (hemi)cellulases, including pentosanases.

EP-A1-0669082 discloses an aqueous bread improver composition comprising at least one water-soluble bread-improving enzyme and optionally a lecithin. The lecithin component, if any, is added in form of an emulsion in water.

WO 98/38869 discloses an edible composition comprising at least two components being encapsulated or coated by a fatty substance. The fatty substances disclosed are optionally esterified mono-, di- and triglycerides and waxes. Lecithins may also be used.

WO 00/01793 discloses an enzyme-containing granular composition comprising an enzyme-containing core and a protective layer or coating.

WO 99/27907 discloses a composition containing an active principle encapsulated in multilamellar vesicles comprising at least one surfactant.

WO 97/16076 discloses a particulate enzyme-containing preparation suitable for e.g. the production of an animal feed composition.

WO 92/12645 discloses the use of an enzyme-containing T-granulate, which is coated with a coating agent comprising a high melting fat or wax, as a component of a mixture which is well-suited as a fodder.

WO 89/08694 discloses an enzyme containing granulate with a coating comprising a mono- or diglyceride of a fatty acid.

WO 90/09440 discloses an enzyme containing granulate having two coatings and an enzyme.

The use of enzymes as dough conditioners is, however, not unproblematical, since such enzymes tend to affect dough properties such as stickiness, strength, or stability. Especially carbohydrases like hemicellulases will result in the dough becoming sticky and consequently difficult to handle both by hand and by machines. It would thus be desirable to be able to delay the contact between the enzyme(s) and the remaining dough components until a selected point in time.

It is one object of the present invention to provide an improved dough comprising one or more encapsulated or coated enzyme(s), wherein the encapsulation or coating controls the release of enzymes into the dough.

It is another object of the invention to provide an improved dough comprising one or more encapsulated or coated enzyme(s), wherein the encapsulated or coated enzyme(s) has a low size allowing good mixability of the enzymes in the dough.

### SUMMARY OF THE INVENTION

The present invention relates to a dough composition comprising:

(i) an effective amount of one or more enzyme(s) encapsulated or coated by a lipid substance, wherein said lipid substance

(a) provides, at a temperature of less than 25° C., a barrier, which inhibits release of said enzyme(s) to the surrounding dough, and

(b) undergoes a phase transition in the temperature range from 25° C. to 60° C. allowing release of said enzyme(s), and

(ii) flour and optionally any additional, conventional dough ingredients.

The present invention also relates to a method for preparing a dough composition, comprising:

Addition of one or more enzyme(s) encapsulated or coated by a lipid substance, wherein said lipid substance

(a) provides, at a temperature of less than 25° C., a barrier, which inhibits release of said enzyme(s) to the surrounding dough, and

(b) undergoes a phase transition in the temperature range from 25° C. to 60° C. allowing release said enzyme(s), to a dough mixture comprising flour and optionally any additional, conventional dough ingredients.

The present invention also relates to a use of one or more lipid-encapsulated or lipid-coated enzyme(s) in a dough composition, wherein said lipid substance undergoes a phase transition in the temperature range from 25° C. to 60° C.

The present invention also relates to a method for improving one or more properties of a dough, comprising adding one or more lipid-encapsulated or lipid-coated enzyme(s) to a dough mixture before baking.

The present invention also relates to a method for preparing a baked product.

The present invention also relates to a dough product and to a baked product.

### DETAILED DESCRIPTION OF THE INVENTION

The present invention relates to a dough composition comprising one or more lipid-encapsulated or lipid-coated enzyme(s) which improve one or more properties of the dough or the baked product obtained from the dough relative to a dough or a baked product in which an enzyme is not incorporated.

The enzyme(s) is/are preferably present in the dough encapsulated in mono-, oligo-, or multi-lamellar vesicles or in the form of coated solid particles or granules. By encapsulating or coating the enzyme(s) a controlled release of said enzymes can be obtained, so that the enzyme(s) are not released to the other dough components until a selected point in time.

By the term “selected point in time” is meant a point in time, in which the effect of the active enzyme is desired. This means that release of the enzyme is inhibited during the initial processing of the dough, at which stage where it would cause undesired effects such as increased stickiness of the dough, reduced machinability, increased softness of the dough, and increased tightness of the dough. Rather it will be released during leavening of the dough, i.e. when the temperature of the dough has increased from usually room temperature to a temperature in the range 25-60° C., preferably to a temperature in the range 35-50° C.

The term “improved property” is defined herein as any property of a dough and/or a product obtained from the dough, particularly a baked product, which is improved by the action of an enzyme relative to a dough or product in which said enzyme is not incorporated. The improved property may include, but is not limited to, increased strength of the dough, increased elasticity of the dough, increased stability of the dough, reduced stickiness of the dough, improved extensibility of the dough, improved machinability of the dough, increased volume of the baked product, improved crumb structure of the baked product, improved softness of the baked product, improved flavor of the baked product, and/or improved antistaling of the baked product.

The use of an enzyme may result in an increased strength, stability, and/or reduced stickiness of the dough, resulting in improved machinability, as well as in an increased volume and improved crumb structure and softness of the baked product. The effect on the dough may be particularly advantageous when a poor quality flour is used. Improved machinability is of particular importance in connection with dough that is to be processed industrially.

The improved property may be determined by comparison of a dough and/or a baked product prepared with and without addition of an enzyme in accordance with the methods of the present invention. organoleptic qualities may be evaluated using procedures well established in the baking industry, and may include, for example, the use of a panel of trained taste-testers.

The term “increased strength of the dough” is defined herein as the property of a dough that has generally more elastic properties and increased resistance towards overmixing.

The term “increased elasticity of the dough” is defined herein as the property of a dough which has a higher tendency to regain its original shape after being subjected to a certain physical strain.

The term “increased stability of the dough” is defined herein as the property of a dough that is less susceptible to mechanical abuse thus better maintaining its shape and volume.

The term “reduced stickiness of the dough” is defined herein as the property of a dough that has less tendency to adhere to surfaces, e.g., in the dough production machinery, and is either evaluated empirically by the skilled test baker or measured by the use of a texture analyzer (e.g., TA-XT2 Texture Analyser available from Stable Micro Systems, England) as known in the art.

The term “improved extensibility of the dough” is defined herein as the property of a dough that can be subjected to increased strain or stretching without rupture.

The term “improved machinability of the dough” is defined herein as the property of a dough that is generally less sticky and/or more firm and/or more elastic.

The term “increased volume of the baked product” is measured as the specific volume of a given loaf of bread (volume/weight) determined typically by the traditional rape seed displacement method.

The term “improved crumb structure of the baked product” is defined herein as the property of a baked product with finer and/or thinner cell walls in the crumb and/or more uniform/homogenous distribution of cells in the crumb and is usually evaluated empirically by the skilled test baker.

The term “improved softness of the baked product” is the opposite of “firmness” and is defined herein as the property of a baked product that is more easily compressed and is evaluated either empirically by the skilled test baker or measured by the use of a texture analyzer (e.g., TA-XT2) as known in the art.

The term “improved flavor of the baked product” is evaluated as mentioned above by a trained test panel.

The term “improved antistaling of the baked product” is defined herein as the properties of a baked product that have a reduced rate of deterioration of quality parameters, e.g., softness and/or elasticity, during storage.

The term “dough” is defined herein as a mixture of flour and other ingredients firm enough to knead or roll. The dough may be fresh, frozen, pre-bared, or pre-baked. The preparation of frozen dough is described by Kulp and Lorenz in Frozen and Refrigerated Doughs and Batters.

The term “baked product” is defined herein as any product prepared from a dough, either of a soft or a crisp character. Examples of baked products, whether of a white, light or dark type, which may be advantageously produced by the present invention are bread (in particular white, whole-meal or rye bread), typically in the form of loaves or rolls, French baguette-type bread, pasta, pita bread, tortillas, tacos, cakes, pancakes, biscuits, cookies, pie crusts, steamed bread, and crisp bread, and the like.

The enzyme(s) may be any enzyme which provides an improved property to a dough and/or to a baked product obtained from the dough. Enzymes to be used according to the invention are preferably selected among carbohydrases, proteases, oxidases, lipases, and transglutaminases.

The source of an enzyme is not critical for improving one or more properties of a dough and/or a baked product. Accordingly, the enzyme(s) may be obtained from any source such as a plant, microorganism, or animal. The enzyme(s) is/are preferably obtained, e.g., from a microbial source, such as a bacterium or a fungus, e.g., a filamentous fungus or a yeast.

In a preferred embodiment, the enzyme(s) is/are obtained from a bacterial source. For example, the enzyme(s) may be obtained from an Acetobacter, Acinetobacter, Agrobacterium, Alcaligenes, Arthrobacter, Azotobacter, Bacillus, Comamonas, Clostridium, Gluconobacter, Halobacterium, Mycobacterium, Rhizobium, Salmonella, Serratia, Streptomyces, Escherichia, Pseudomonas, Wolinella, or methylotrophic bacterium strain.

In a more preferred embodiment, the enzyme(s) is/are obtained from an Acetobacter aceti, Alcaligenes faecalis, Arthrobacter oxidans, Azotobacter vinelandii, Bacillus alkalophilus, Bacillus amyloliquefaciens, Bacillus anitratum, Bacillus brevis, Bacillus circulans, Bacillus coagulans, Bacillus lautus, Bacillus lentus, Bacillus licheniformis, Bacillus megaterium, Bacillus stearothermophilus, Bacillus subtilis, Bacillus thuringiensis, Comamonas testosteroni, Clostridium tyrobutyricum, Gluconobacter dioxyaceticus, Gluconobacter liquefaciens, Gluconobacter suboxydans, Halobacterium cutirubrum, Mycobacterium convolutum, Rhizobium melioti, Salmonella typhimurium, Serratia marcescens, Streptomyces lividans, Streptomyces murinus, Escherichia coli, Pseudomonas aeruginosa, Pseudomonas fluorescens, Pseudomonas putida, or Wolinella succinogens strain.

In another preferred embodiment, the enzyme(s) is/are obtained from a fungal source. For example, the enzyme(s) may be obtained from a yeast strain such as a Candida, Kluyveromyces, Pichia, Saccharomyces, Schizosaccharomyces, or Yarrowia strain; or from a filamentous fungal strain such as an Acremonium, Aspergillus, Aureobasidium, Chrysosporium, Cryptococcus, Filibasidium, Fusarium, Humicola, Magnaporthe, Monilia, Mucor, Myceliophthora, Neocallimastix, Neurospora, Paecilomyces, Penicillium, Phanerochaete, Piromyces, Schizophyllum, Sclerotium, Sporotrichum, Talaromyces, Thermoascus, Thielavia, Tolypocladium, or Trichoderma strain.

In another more preferred embodiment, the enzyme(s) is/are obtained from a Saccharomyces carlsbergensis, Saccharomyces cerevisiae, Saccharomyces diastaticus, Saccharomyces douglasii, Saccharomyces kluyveri, Saccharomyces norbensis, or Saccharomyces oviformis strain.

In another more preferred embodiment, the enzyme(s) is obtained from an Aspergillus aculeatus, Aspergillus awamori, Aspergillus foetidus, Aspergillus japonicus, Aspergillus nidulans, Aspergillus niger, Aspergillus oryzae, Chrysosporium lignorum, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sulphureum, Fusarium toruloseum, Fusarium trichothecioides, Fusarium venenatum, Humicola insolens, Humicola lanuginosa, Monilia sitophila, Mucor miehei, Myceliophthora thermophila, Neurospora crassa, Penicillium purpurogenum, Phanerochaete chrysporum, Polyporus pinsitus, Polyporus versicolor, Sclerotium rolfsii, Sporotrichum thermophile, Trichoderma citrinoviride, Trichoderma hamatum, Trichoderma harzianum, Trichoderma koningii, Trichoderma longibrachiatum, Trichoderma polysporum, Trichoderma reesei, Trichoderma saturnisporum, or Trichoderma viride strain.

It is to be understood that enzyme variants (produced, for example, by recombinant techniques) are included within the meaning of the term “enzyme”. Examples of such enzyme variants are disclosed, e.g., in EP 251,446 (Genencor), WO 91/00345 (Novo Nordisk), EP 525,610 (Solvay) and WO 94/02618 (Gist-Brocades Nev.). The enzyme classification employed in the present specification and claims is in accordance with Recommendations (1992) of the Nomenclature Committee of the International Union of Biochemistry and Molecular Biology, Academic Press, Inc., 1992.

Accordingly the types of enzymes which may appropriately be used according to the invention include oxidoreductases (EC 1. -.-.-), transferases (EC 2.-.-.-), hydrolases (EC 3.-.-.-), lyases (EC 4.-.-.-), isomerases (EC 5.-.-.-) and ligases (EC 6.-.-.-).

Preferred oxidoreductases in the context of the invention are peroxidases (EC 1.11.1) such as haloperoxidase, laccases (EC 1.10.3.2) and glucose oxidases (EC 1.1.3.4), while preferred transferases are transferases in any of the following subclasses: a) Transferases transferring one-carbon groups (EC 2.1); b) Transferases transferring aldehyde or ketone residues (EC 2.2); acyltransferases (EC 2.3); c) Glycosyltransferases (EC 2.4); d) Transferases transferring alkyl or aryl groups, other than methyl groups (EC 2.5); and e) Transferases transferring nitrogenous groups (EC 2.6).

A most preferred type of transferase in the context of the invention is a transglutaminase (protein-glutamine γ-glutamyltransferase; EC 2.3.2.13).

Further examples of suitable transglutaminases are described in WO 96/06931 (Novo Nordisk A/S).

Preferred hydrolases in the context of the invention are: Carboxylic ester hydrolases (EC 3.1.1.-) such as lipases (EC 3.1.1.3); phytases (EC 3.1.3.-), e.g. 3-phytases (EC 3.1.3.8) and 6-phytases (EC 3.1.3.26); glycosidases (EC 3.2, which fall within a group denoted herein as “carbohydrases”), such as—amylases (EC 3.2.1.1); peptidases (EC 3.4, also known as proteases); and other carbonyl hydrolases.

In the present context, the term “carbohydrase” is used to denote not only enzymes capable of breaking down carbohydrate chains (e.g. starches) of especially five- and six-membered ring structures (i.e.glycosidases, EC 3.2), but also enzymes capable of isomerizing carbohydrates, e.g. six-membered ring structures such as D-glucose to five-membered ring structures such as D-fructose.

Carbohydrases of relevance include the following (EC numbers in parentheses): α-amylases (3.2.1.1), P-amylases (3.2.1.2), glucan 1,4-β-glucosidases (3.2.1.3), cellulases (3.2.1.4), endo-1,3(4)-β-glucanases (3.2.1.6), endo-1,4- -xylanases (3.2.1.8), dextranases (3.2.1.11), chitinases (3.2.1.14), polygalacturonases (3.2.1.15), lysozymes (3.2.1.17), β-glucosidases (3.2.1.21), α-galactosidases (3.2.1.22), β-galactosidases (3.2.1.23), amylo-1,6-glucosidases (3.2.1.33), xylan 1,4-p-xylosidases (3.2.1.37), glucan endo-1,3-β-D-glucosidases (3.2.1.39), α-dextrin endo-1,6-α-glucosidases (3.2.1.41), sucrose a-glucosidases (3.2.1.48), glucan endo-1,3-α-glucosidases (3.2.1.59), glucan 1,4-β-glucosidases (3.2.1.74), glucan endo-1,6-β-glucosidases (3.2.1.75), arabinan endo-1,5-α-L-arabinosidases (3.2.1.99), lactases (3.2.1.108), chitosanases (3.2.1.132) and xylose isomerases (5.3.1.5).

Examples of commercially available oxidoreductases (EC 1.-.-.-) include Gluzyme™ (enzyme available from Novo Nordisk A/S).

Examples of commercially available proteases (peptidases) include Kannase™, Everlase™, Esperase™, Alcalase™, Neutrase™, Durazym™, Savinase™, Pyrase™, Pancreatic Trypsin NOVO (PTN), Bio-FeedTm Pro and Clear-Lens™ Pro (all available from Novo Nordisk A/S, Bagsvaerd, Denmark).

Other commercially available proteases include Maxatase™, Maxacal™, Maxapem™, Opticlean™ and Purafect™ (available from Genencor International Inc. or Gist-Brocades).

Examples of commercially available lipases include Lipoprime™ Lipolase™, Lipolase™ Ultra, LipoZyme™, Palatase™, Novozym™ 435 and Lecitase™ (all available from Novo Nordisk A/S). Other commercially available lipases include Lumafast™ (Pseudomonas mendocina lipase from Genencor International Inc.); Lipomax™ (Ps. pseudoalcaligenes lipase from Gist-Brocades/Genencor Int. Inc.; and Bacillus sp. lipase from Solvay enzymes.

Examples of commercially available carbohydrases include Alpha-Gal™, Bio-Feed™ Alpha, Bio-Feed™ Beta, Bio-Feed™ Plus, Bio-Feed™ Plus, Novozyme™ 188, Celluclast™, Cellusoft™, Ceremyl™, Citrozym™, Denimax™, Dezyme™, Dextrozyme™, Finizym™, Fungamyl™, Gamanase™, Glucanex™, Lactozym™, Maltogenase™, Pentopan™, Pectinex™, Promozyme™, Pulpzyme™, Novamyl™, Termamyl™, AMG™ (Amyloglucosidase Novo), Maltogenase™, Sweetzyme™ and Aquazym™ (all available from Novo Nordisk A/S).

Combinations of enzymes may be obtained by fermenting two or more enzymes simultaneously in the same fermentation broth. Alternatively combinations of enzymes may be obtained by fermenting the enzymes separately and using mixtures of different fermentation broths.

Carbohydrases, such as amylases and pentosanases, may beneficially be added to flour in order to improve one or more properties thereof.

Flour has varying content of amylases leading to differences in the baking quality. Addition of amylases can be necessary in order to standardise the flour. Amylases and pentosanases generally provide sugar for the yeast fermentation, improve the bread volume, retard retrogradation, and decrease the staling rate and stickiness that result from pentosan gums.

Certain maltogenic amylases can be used for prolonging the shelf life of bread for two or more days without causing gumminess in the product. These enzymes selectively modify the gelatinised starch by cleaving from the non-reducing end of the starch molecules to produce low molecular weight sugars and dextrins. The starch is modified in such a way that retrogradation is less likely to occur. The produced low-molecular-weight sugars improve the water retention capacity of the baked goods without creating the intermediate-length dextrins that result in gumminess in the finished product.

Fungal α-amylases may be used to improve the bread volume and to provide a good and uniform structure of the bread crumb.

Said α-amylases are endoenzymes that produce maltose, dextrins and glucose. Cereal and some bacterial -amylases are inactivated at temperatures above the gelatinisation temperature of starch, and therefore when added to a wheat dough result in a low bread volume and a sticky bread interior. Fungal amylases, such as Fungamyl™, have the advantage of being thermolabile and are inactivated just below the gelatinisation temperature.

Enzyme preparations containing a number of pentosanase and hemi-cellulase activities can improve the handling and stability of the dough, and improves the freshness, the crumb structure and the volume of the bread.

By hydrolysing the pentosans fraction in flour, it will lose a great deal of its water-binding capacity, and the water will then be available for starch and gluten. The gluten becomes more pliable and extensible, and the starch gelatinise more easily. Pentosanases can be used in combination with or as an alternative to emulsifiers.

In a preferred embodiment of the invention the one or more lipid-encapsulated or lipid-coated enzymes is/are selected among a-amylase and hemicellulase. In a particular embodiment, said hemicellulase is a pentasanase, such as a xylanase.

The xylanase is preferably of microbial origin, e.g., derived from a bacterium or fungus, such as a strain of Aspergillus, in particular of Aspergillus aculeatus, Aspergillus niger (cf. WO 91/19782), Aspergillus awamori (WO 91/18977), or Aspergillus tubigensis (WO 92/01793), from a strain of Trichoderma, e.g., Trichoderma reesei, or from a strain of Humicola, e.g., Humicola insolens (WO 92/17573, the contents of which is hereby incorporated by reference).

Proteases may also be used according to the invention, as these enzymes may be useful for gluten weakening in particular when using hard wheat flour.

Further useful enzymes comprise oxidases, which are useful for improving dough consistency.

In a preferred embodiment of the invention the oxidase is an aldose oxidase, a glucose oxidase, a pyranose oxidase, a lipoxygenase or an L-amino acid oxidase.

In another embodiment of the invention the enzyme is a lipase, which is useful for the modification of lipids present in the dough or dough constituents so as to soften the crumb.

In a preferred embodiment, the enzyme(s) has/have a pH optimum in the range of about 3 to about 10. In a more preferred embodiment, the enzyme(s) has/have a pH optimum in the range of about 4.5 to about 8.5.

In another preferred embodiment, the enzyme(s) has/have a temperature optimum in the range of about 5° C. to about 100° C.

In a more preferred embodiment, the enzyme(s) has/have a temperature optimum in the range of about 25° C. to about 75° C.

According to the present invention, combinations of enzymes may also be used to improve one or more properties of the dough and/or baked product obtained from the dough. In a preferred embodiment, the combination comprises a xylanase in combination with an amylase, or combinations of a xylanase and an amylase with a glucose-oxidase or a lipase.

The enzyme(s) is/are used in an amount sufficient to provide the desired effect, i.e., the improved properties in question. Thus, the dosage of the enzyme(s) to be used in the present invention should be adapted to the nature and composition of the dough in question as well as to the nature of the enzyme(s) to be used.

The enzyme(s) is/are typically added in an amount corresponding to 0.01-100 mg enzyme protein per kg of flour, preferably 0.1-25 mg enzyme protein per kg of flour, more preferably 0.1-5 mg enzyme protein per kg of flour.

In terms of enzyme activity, the appropriate dosage of a given enzyme for exerting a desirable improvement of dough and/or baked products will depend on the enzyme and the enzyme substrate in question. The skilled person may determine a suitable enzyme unit dosage on the basis of methods known in the art.

According to the invention the enzyme(s) is/are encapsulated or coated by a lipid substance, wherein said lipid substance a) provides, at a temperature of less than 25° C., a barrier, which inhibits release of said enzyme(s) to the surrounding dough, and b) undergoes a phase transition in the temperature range from 25° C. to 60° C. In a preferred embodiment of the invention at least 75% by weight of said lipid substance undergoes a phase transition within a temperature interval of less than 20° C., comprised in the range 25-60° C. Said phase transition of the lipid substance is preferably from a lamellar to a non-lamellar phase. In a particular embodiment said phase transition is melting. Without wishing to be bound by any particular theory it is thought that the release of enzyme(s) encapsulated or coated with a lipid substance, such as from multilamellar phosphoglyceride vesicles occurs as a consequence of a temperature-dependent phase transition of said vesicles, cf. “Influence of Ether Linkage on the Lamellar to Hexagonal Phase Transition of Ethanolamine Phospholipids”, J. M:Boggs et al., Biochemistry 1981, 20, 5728-5735. By selecting a lipid substance displaying a phase transition in the above range it is assured that the encapsulated or coated enzyme(s) is/are not released during the initial processing of the dough. Rather the enzyme(s) is/are released during leavening and/or early baking, i.e. at a point in time where its/their activity is desired.

In a preferred embodiment, use is made of a lipid substance, wherein at least 85% by weight of said lipid substance undergoes a phase transition within a temperature interval of less than 15° C. In another preferred embodiment of the invention at least 90% by weight of said lipid substance undergoes a phase transition within a temperature interval of less than 12° C. In a most preferred embodiment at least 95% by weight of said lipid substance undergoes a phase transition within a temperature interval of less than 10° C.

In the application of an enzyme for use in a dough an important property of an enzyme entity, such as an enzyme granule, is the size and/or the size distribution of the entity as the application of an enzyme entity involves mixing the entities with other particulate products, particularly flour. Use of an enzyme entity of a proper size in such compositions may provide a more homogeneous distribution of the enzyme entity in the composition and a less tendency of the enzyme entities separating from the other composition components. If the enzyme entities do not possess the proper size distribution compared to the composition in which they are used the enzyme entity may concentrate in specific parts or layers of the composition. Also the average particle size of the entities should not be too large, since they would then tend not to remain intact during the mixing process. The term particle size as used herein is to be understood as the diameter of the particle measured in its longest dimension.

In a particular embodiment of the invention the lipid-encapsulated or lipid-coated enzyme(s) is/are provided in the form of particles, wherein at least 95% by weight thereof have a particle size in the range 10-200 μm. In a further embodiment of the invention the above particle size is in the range 20-150 μm.

The enzyme(s) and/or additional enzymes to be used according to the present invention may be in any form suitable for the use in question, e.g., in the form of a dispersion of vesicle encapsulated enzyme(s) or in the form of a dry powder of coated agglomerated or granulated particles, in particular a non-dusting granulate.

Enzyme Vesicles

In the case that the enzyme(s) are encapsulated they are preferably used in the form of vesicles, i.e. the enzyme(s) are encapsulated by a multilamellar bilayer of lipid substance. In a preferred embodiment said vesicles are comprised of one or more lipid substances. Generally any lipid substance undergoing a phase transition in the above range to release the enzyme(s) and suitable for preparing vesicles may be employed. However, in a preferred embodiment said lipid substance comprises a phosphoglyceride, such as phosphatidylethanolamine (PE), phosphatidylcholine (PC) or derivatives thereof. By the term “derivatives thereof” in the present context, is meant esters, ethers, anhydrides, salts etc. of the phosphoglycerides in question.

In a particular embodiment said phosphoglyceride is selected among egg phosphatidylethanolamine, transesterified phosphatidylethanolamine, N-methyl-di-oleoyl phosphatidylethanolamine,and dimyristoyl phosphaphosphatidylcholine.

In a particular embodiment of the invention it may be desirable to use the above phosphoglyceride in admixture with one or more components selected among saturated or mono- or polyunsaturated, linear or branched C6-C22 fatty acids and edible, amphiphilic polymers, preferably of sugar or cellulose origin. In a preferred embodiment of the invention one of the above phosphoglycerides is used in admixture with a C12-C22 fatty acid, such as myristic acid.

The choice of lipid composition, pH, and salt concentration determine the stability and the release profile of the entrapped enzyme(s). The above listed lipids provide onset temperatures for release between 25 and 60° C., in particular between 35 and 50° C.

These vesicles may be prepared by the following process:

(i) mixing a buffered enzyme containing liquid with a lipid substance to produce a dispersion,

(ii) forming at least one lipid bilayer around enzyme by repeatedly cooling and heating under agitation the dispersion,

(iii) adding a dispersion of the enzyme containing vesicles obtained in step (i) and (ii) to a dough mixture comprising flour and any additional, conventional dough ingredients.

The enzyme containing liquid of step (i) is preferably an aqueous enzyme solution of dispersion and the lipid substance is preferably added in dry form under vigorous mixing. The cooling and heating/mixing procedure of step (ii) is suitably repeated about 5 to 15 times. The cooling is preferably rapidly by placing the dispersion e.g. in a bath of ethanol and solid carbon dioxide (dry ice). While heating it is important that the temperature does not exceed the onset temperature for release of the specific system. If needed, the entrapped volume may be further increased by extrusion or ultrasonic treatment of the system as described in Hope et al., 1985 (Biochemica et Biophysica Acta 812: 55-65).

In the case where the encapsulated enzyme(s) is in the form of vesicles, said vesicles are preferably added to the dough as a buffered dispersion in water. Buffers for use in the preparation of said enzyme vesicles are any conventionally used buffer known in the art, such as a phosphate buffer.

Coated Enzymes

The encapsulated or coated enzyme(s) for use in the dough composition according to the invention may also be in the form of solid coated particles comprising an enzyme-containing core and a coating of a lipid substance. Said particles may be prepared by any granulation technique known in the art. Known formulation technologies include:

spray-dried products, wherein a liquid enzyme-containing solution is atomised in a spray drying tower to form small droplets which during its way down the drying tower dries up to form an enzyme- containing particulate material. Very small particles can be produced this way (Michael S. Showell (editor); Powdered detergents; Surfactant Science Series; 1998; vol. 71; page 140-142; Marcel Dekker).

Layered products, wherein the enzyme is coated as a layer around a preformed core particle, wherein an enzyme-containing solution is atomised, typically in a fluid-bed apparatus wherein the preformed core particles are fluidised, and the enzyme-containing solution adheres to the core particles and dries up to leave a layer of dry enzyme on the surface of the core particle. Particles of a desired size can be obtained this way if a useful core particle of the desired size can be found. This type of product is described in e.g. WO 97/23606.

Prilled products, wherein an enzyme powder is suspended in molten wax and the suspension is sprayed, e.g. through a rotating disk atomiser, into a cooling chamber where the droplets quickly solidify (Michael S. Showell (editor); Powdered detergents; Surfactant Science Series; 1998, vol. 71; page 140-142; Marcel Dekker.

Mixer granulation products, wherein an enzyme-containing liquid is added to a dry powder composition of conventional granulating components. The liquid and the powder in a suitable proportion is mixed in and as the moisture of the liquid is absorbed in the dry powder, the components of the dry powder will start to adhere and agglomerate and particles will build up forming granules comprising the enzyme. Such a process is described in U.S. Pat. No. 4,106,991 (NOVO NORDISK) and related documents EP 170360 B1 (NOVO NORDISK), EP 304332 B1 (NOVO NORDISK), EP 304331 (NOVO NORDISK), WO 90/09440 (NOVO NORDISK) and WO 90/09428 (NOVO NORDISK), and

Extruded or pelletised products, wherein an enzyme-containing paste is pressed to pellets or extruded under pressure through a small opening and cut into particles which are subsequently dried. Such particles usually have a considerable size because the material of which the extrusion opening is made (usually a plate with bore holes) sets a limit on the allowable pressure drop over the extrusion opening, and since very high extrusion pressures, when using a small opening, would increase heat generation in the enzyme paste, which is harmful to the enzyme. (Michael S. Showell (editor); Powdered detergents; Surfactant Science Series; 1998; vol. 71; pages 140 to 142; Marcel Dekker).

In a preferred embodiment of the invention the granules are produced by spray-drying, since said technique provides very small particles, which is favourable in terms of mixing with flour.

In an alternative preferred embodiment the granules are produced via a mixer granulation technique as disclosed above.

Subsequent to the preparation of the enzyme-containing cores, a lipid coating is applied on said cores. The coating is preferably applied in a conventional fluid-bed coating process, wherein the lipid-coating material is sprayed in liquid form onto fluidised enzyme particles. Examples of suitable coating materials comprise the following:

high melting fats such as glycerol esters (mono-, di- or triesters or mixtures thereof),

lipids such as phosphoglycerides,

waxes isolated from a natural source, such as Carnauba wax, Candelilla wax and bees wax. Other natural waxes or derivatives thereof are waxes derived from animals or plants, e.g. of marine origin. Examples of such waxes are hydrogenated ox tallow, hydrogenated palm oil, hydrogenated cotton seed oil and/or hydrogenated soy bean oil, wherein the term “hydrogenated” as used herein is to be construed as saturation of unsaturated hydrocarbon chains, e.g. in triglycerides, wherein carbon=carbon double bonds are converted to carbon-carbon single bonds. The degree of hydrogenation may be optimised by the skilled person to obtain suitable phase transition properties of the hydrogenated lipis substance. An example of hydrogenated palm oil is commercially available, e.g. from Hobum Oele und Fette GmbH, Germany or Deutsche Cargill GmbH, Germany,

fatty acid alcohols, such as linear long chain fatty acid alcohols such as NAFOL 1822 (C18, 20, 22) from Condea Chemie GmbH, Germany, having a melting point between 55-60° C.,

Mono-glycerides and/or di-glycerides, such as glyceryl stearate. An example of this is Dimodan PM from Danisco Ingredients, Denmark.

Fatty acids, such as hydrogenated, linear, long-chained fatty acids.

Paraffins, i.e. solid hydrocarbons,

Micro-crystalline wax.

Enzyme particles or granules typically also comprise auxiliary compounds such as:

a) Edible fillers such as fillers conventionally used in the field of granulation, e.g. water soluble and/or insoluble inorganic salts such as finely ground alkali or alkaline earth sulphate, alkali carbonate and/or alkali halide, clays such as kaolin (e.g. Speswhite, English China Clay), bentonites, talcs, zeolites, and/or silicates.

b) Edible binders such as binders conventionally used in the field of granulation, e.g. binders with a high melting point or no melting point at all and of a non-waxy nature, e.g. polyvinyl pyrrolidone, dextrins, polyvinylalkohol, cellulose derivatives, for example hydroxypropyl cellulose, methyl cellulose or CMC. A suitable binder is a carbohydrate binder such as Glucidex 21D available from Roquette Freres, France.

c) Edible fibre materials such as fibres conventionally used in the field of granulation. Pure or impure cellulose in fibrous form can be sawdust, pure fibrous cellulose, cotton, or other forms of pure or impure fibrous cellulose. Also, filter aids based on fibrous cellulose can be used. Several brands of cellulose in fibrous form are on the market, e.g. CEPO™ and ARBOCEL™. In a publication from Svenska Tramjolsfabrikerna AB, “Cepo Cellulose Powder” it is stated that for Cepo S/20 cellulose the approximate maximum fibre length is 500 μm, the approximate average fibre length is 160 μm, the approximate maximum fibre width is 50 μm and the approximate average fibre width is 30 μm. It is also stated that CEPO SS/200 cellulose has an approximate maximum fibre length of 150 μm, an approximate average fibre length of 50 μm, an approximate maximum fibre width of 45 μm and an approximate average fibre width of 25 μm. Cellulose fibres with these dimensions are very well suited for the purpose of the invention. A preferred fibrous cellulose is Arbocel BFC200.

d) Edible enzyme stabilising or protective agents such as conventionally used in the field of granulation. Stabilising or protective agents may fall into several categories: alkaline or neutral materials, reducing agents, antioxidants and/or salts of first transition series metal ions. Each of these may be used in conjunction with other protective agents of the same or different categories. Examples of alkaline protective agents are alkali metal silicates, -carbonates or bicarbonates, which provide a chemical scavenging effect by actively neutralising e.g. oxidants. Examples of antioxidants are methionine, butylated hydroxytoluene (BHT) or butylated hydroxyanisole (BHA) or ascorbic acid or salts thereof.

e) Edible sugars may act as process aid.

One or more additional enzymes may also be incorporated into the dough. The additional enzyme may be of any origin, including mammalian and plant, and preferably of microbial (bacterial, yeast or fungal) origin and may be obtained by techniques conventionally used in the art.

In a preferred embodiment, the additional enzyme may be a cyclodextrin glucanotransferase, a peptidase, in particular, an exopeptidase (useful in flavour enhancement), a phospholipase (useful for the modification of lipids present in the dough or dough constituents so as to soften the dough and improve gas retention in the dough), a cellulase, a protein disulfide isomerase, e.g., a protein disulfide isomerase as disclosed in WO 95/00636, a glycosyltransferase, a peroxidase (useful for improving the dough consistency), or a laccase.

In addition, or as an alternative to additional enzyme components, a conventionally used baking agent may also be incorporated into the dough. The baking agent may include proteins, such as milk powder (to provide crust colour), gluten (to improve the gas retention power of weak flours), and soy (to provide additional nutrients and improve water binding); eggs (either whole eggs, egg yolks or egg whites); fat such as granulated fat or shortening (to soften the dough and improve the texture of the bread); an emulsifier (to improve dough extensibility and, to some extent, the consistency of the resulting bread); an antioxidant, e.g., ascorbic acid, an oxidant such as potassium bromate, potassium iodate, azodicarbon amide (ADA) or ammonium persulfate (to strengthen the gluten structure); an amino acid, e.g., L-cysteine (to improve mixing properties); a sugar; a salt, e.g., sodium chloride, calcium acetate, sodium sulfate or calcium sulphate (to make the dough firmer); flour; and starch. Such components may also be added to the dough in accordance with the methods of the present invention.

Examples of suitable emulsifiers are mono- or diglycerides, diacetyl tartaric acid esters of mono- or diglycerides, sugar esters of fatty acids, polyglycerol esters of fatty acids, lactic acid esters of monoglycerides, acetic acid esters of monoglycerides, polyoxyethylene stearates, phospholipids, and lecithin.

The dough and/or baked product prepared by a method of the present invention may be based on wheat meal or flour, optionally in combination with other types of meal or flour such as corn meal, corn flour, rye meal, rye flour, oat meal, oat flour, soy meal, soy flour, sorghum meal, sorghum flour, potato meal, or potato flour.

The handling of the dough and/or baking may be performed in any suitable manner for the dough and/or baked product in question, typically including the steps of kneading the dough, subjecting the dough to one or more proofing treatments, and baking the product under suitable conditions, i.e., at a suitable temperature and for a sufficient period of time. For instance, the dough may be prepared by using conventional methods such as a normal straight dough process, a sour dough process, an overnight dough method, a low-temperature and long-time fermentation method, a frozen dough method, the Chorleywood Bread process, or the Sponge and Dough process.

From the above disclosure it will be apparent that the dough of the invention is generally a leavened dough or a dough to be subjected to leavening. The dough may be leavened in various ways such as by adding sodium bicarbonate or the like, or by adding a leaven (fermenting dough), but it is preferable that the dough be leavened by adding a suitable yeast culture, such as a culture of Saccharomyces cerevisiae (baker's yeast). Any of the commercially available Saccharomyces cerevisiae strains may be employed.

The present invention also relates to methods for preparing a baked product, comprising baking a dough obtained by a method of the present invention to produce a baked product. The baking of the dough to produce a baked product may be performed using methods well known in the art.

The present invention also relates to doughs and baked products, respectively, produced by the methods of the present invention.

The present invention is further described by the following examples that should not be construed as limiting the scope of the invention.

### EXAMPLES

### Example 1

Production of Xylanase Containing Vesicles for use in a Dough Improver According to the Invention

100 μl samples of L-α-phosphatidylethanolamine (egg) (20 mg/ml) in chloroform from Avanti polar lipids, Inc. was added to glass tubes and dried in a speed vac. Then 425 μl 0.1M sodium phosphate, pH 7.4 and 75 μl Thermomyces lanuginosus xylanase (6mg/ml) (prepared as disclosed in WO 96/23062) was added to each tube. As a control 500 μl buffer without xylanase was added to one tube.

All samples were vigorously mixed and then rapidly frozen by placing the tubes in an ethanol/dry-ice bath. Subsequently the samples were thawed and vigorously mixed. This freeze-thaw procedure was repeated 10 times and the samples were transferred to Eppendorf tubes and centrifuged at 15,000 g for 4 minutes. After centrifugation the supernatant was removed and 1 ml 0.1M sodium phosphate buffer was added to the precipitated vesicles. The samples were then vigorously mixed, centrifuged again at 15,000 g for 1 minute, and the supernatant removed. This washing was repeated 4 times and the vesicles were finally diluted to 8 mg/ml in the sodium phosphate buffer and stored at 4° C.

### Example 2

Release of Xylanase Activity from Vesicles Prepared in Example 1.

200 μl 0.4% AZCL-xylan from MegaZyme in 0.1M sodium phosphate buffer, pH 7.4 and 200 μl of a diluted enzyme solution or vesicle suspension (diluted in the same buffer) was mixed in Eppendorf tubes, and the samples were incubated for 15 minutes at either 25° C. or 50° C. The samples were then centrifuged for 30 seconds at 15,000 g and 200 μl of the supernatant from each sample was transferred to 96-well microtiter plates. Finally the absorption of the samples at 590 nm was measured and the corresponding xylanase activity read from a standard curve.

The results are given in table 1 below. Table 1. Xylanase activity in vesicles.

| | | Activity | Activity | Concen- | Activity |
|---|---|---|---|---|---|
| | Dilution | (A590 nm) | (A590 nm) | tration | ratio |
| Enzyme | factor | 25° C. | 50° C. | (μg/ml) | 50/25° C. |
| xylanase | 20,000 | 0.029 | 0.047 | 809 | 1.6 |
| xylanase | 10,000 | 0.055 | 0.107 | 836 | 1.9 |
| xylanase | 5,000 | 0.1085 | 0.247 | 922 | 2.3 |
| PE- | 100 | 0.0325 | 0.3285 | 24 | 10.1 |
| xylanase | | | | | |
| PE- | 50 | 0.07 | 0.7115 | 26 | 10.2 |
| xylanase | | | | | |

A 10 fold increase in the xylanase activity was observed for the encapsulated xylanase when the temperature was increased from 25 to 50° C. For the non-encapsulated xylanase only a 2 fold thermal activation was observed, thus showing that xylanase activity is released from the vesicles upon increasing temperature and that leakage of xylanase from the vesicles at lower temperatures was limited.

### Example 3

Test of Encapsulated Pentopan™ Mono in Micro Scale Baking Assay

A controlled release system according to the present invention in which a xylanase (Pentopan™ Mono) has been encapsulated in a lipid matrix using the same method as described in Example 1 above was tested in a micro scale baking assay using a normal straight dough procedure and 12 g of flour for each dough. The obtained results were compared to a regular Pentopan™ Mono baking granulate. Micro scale baking:

Bread was made according to a standardised procedure for micro scale baking.

Ingredients:

| | |
|---|---|
| Water | 61% |
| Flour | 100% |
| Yeast | 4% |
| Sugar | 1.5% |
| Salt | 1.5% |
| Ascorbic acid | 30 ppm |

For each dough 12 g of regular wheat flour was used. The amount of flour was 100% by weight and the amounts of the other ingredients were calculated relative to that according to the above.

The flour was incubated in a heating cabinet (28° C.) for two days before dough preparation. Also water temperature was adjusted to obtain a dough temperature of 27° C. Yeast, salt, and sugar were added as a water solution with the respective concentrations of 0.67 g/ml for yeast, 0.072 g/ml for sugar, and 0.072 g/ml for salt.

The encapsulated enzyme, Pentopan™ Mono, was added as a vesicle dispersion in water.

The ingredients were then combined and the dough was mixed on the Micro Mixer NSI-33R for 3.5 minutes.

After mixing the dough was incubated in a heating cabinet at 28° C. for 15 minutes after which stickiness and softness were evaluated.

The dough was then moulded and sheeted and incubated in the heating cabinet at 28° C. for 10 minutes. Moulding and sheeting was repeated and the dough was placed in a 37 ml pan, which was then incubated in a heating cabinet at 32° C. and 85% relative humidity for 45 minutes.

The dough was baked at 230° C. for 17 minutes and volume was evaluated after cooling of the bread.

Dough samples were made according to table 2 below.

TABLE 2
Baking plan

| | | Pentopan ™ | | |
|---|---|---|---|---|
| | Pentopan ™ | Mono | | |
| Dough | Mono | (Baking | Control | |
| No. | (Encapsulated) | granulate) | lipid | Fungamyl ™ |
| 1 | | 100 FXU/kg | | 10 FAU/kg |
| | | flour | | flour |
| 2 | | 100 FXU/kg | 250 μl | 10 FAU/kg |
| | | flour | | flour |
| 3 | | 300 FXU/kg | | 10 FAU/kg |
| | | flour | | flour |
| 4 | 300 FXU/kg | | | 10 FAU/kg |
| | flour | | | flour |
| 5 | 300 FXU/kg | | | 10 FAU/kg |
| | flour | | | flour |
| 6 | | 300 FXU/kg | | 10 FAU/kg |
| | | flour | | flour |

FXU = Fungal Xylanase Units,
FAU = Fungal Amylase Units

The evaluation of stickiness and softness and the volume index are given in table 3. Stickiness and softness are evaluated by comparing all the dough samples to the reference dough no. 1 (100 FXU and 10 FAU per kg flour). The dough samples are scored on a ten point scale, in which the reference sample no. 1 gets a score of 5.

The volume index is also calculated by using dough sample no. 1 as reference (index=100%). All other volumes are given relative to the reference. The scores for dough samples 3 to 6 are given as the average of the double determination.

TABLE 3
Evaluation of stickiness, softness and volume index.

| Sample no. | 1 | 3 and 6 | 4 and 5 | 2 |
|---|---|---|---|---|
| Stickiness | 5.00 | 6.50 | 4.25 | 5.50 |
| St. dev. | — | 0.0 | 0.35 | — |
| Softness | 5.00 | 6.50 | 4.25 | 5.00 |
| St. dev. | — | 0.0 | 0.35 | — |
| Volume index (%) | 100.0 | 107.4 | 109.8 | 104.5 |
| St. dev. | — | 0.0 | 0.0 | — |

It is seen that encapsulation markedly reduces the stickiness induced by the xylanase. Adding 300 FXU Pentopan™Mono/kg flour in the form of a baking granulate (BG) to the dough results in an increased stickiness compared to what is obtained with 100 FXU/kg flour (BG). Encapsulation of the enzyme according to the invention reduces the observed stickiness markedly. The dough with 300 FXU encapsulated Pentopan™ Mono is significantly less sticky than the dough with only 100 FXU Pentopan™ Mono (BG).

Similar results are obtained for dough softness.

A bread with 300 FXU encapsulated Pentopan™ Mono furthermore gives bread with a better volume than bread with 300 FXU Pentopan™ Mono as a baking granulate (BG).

The lipid used for encapsulation of the xylanase was included as a control. The lipid makes the dough slightly stickier than the reference sample (100 FXU as BG), which means that the reduced stickiness of the encapsulated xylanase (samples 4 and 5) must be due to a delayed release of the xylanase and not an effect of the lipid used for the encapsulation. The control lipid gives a volume increase compared to the reference sample (100 FXU as BG).

The invention described and claimed herein is not to be limited in scope by the specific embodiments disclosed herein, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended any of claims.

Various references are cited herein, the disclosures of which are incorporated by reference in their entireties.

1. A dough composition comprising:
(i) an effective amount of one or more enzyme(s) encapsulated or coated by a lipid substance, wherein said lipid substance:
(a) inhibits release of said enzyme(s) to the surrounding dough at a temperature of less than 25° C., and
(b) undergoes a phase transition in the temperature range from 25° C. to 60° C. allowing release of said enzyme(s), and
(ii) flour.

2. The dough composition according to claim 1, wherein at least 75% by weight of said lipid substance undergoes a phase transition within a temperature interval of less than 20° C., comprised in the range from 25 to 60° C.

3. The dough according to claim 1, wherein the said phase transition is from a lamellar to a non-lamellar phase.

4. The dough composition according to claim 1, wherein the said phase transition is melting.

5. The dough composition according to claim 1, wherein at least 85% by weight of the said lipid substance undergoes the said phase transition within a temperature interval of less than 15° C.

6. The dough composition according to claim 1, wherein at least 90% by weight of the said lipid substance undergoes the said phase transition within a temperature interval of less than 12° C.

7. The dough composition according to claim 1, wherein at least 95% by weight of the said lipid substance undergoes the said phase transition within a temperature interval of less than 10° C.

8. The dough composition according to claim 1, wherein said one or more enzyme(s) are selected among carbohydrases, proteases, oxidases, lipases, and transglutaminases.

9. The dough composition according to claim 8, wherein said carbohydrase is selected among a-amylase and hemicellulase.

10. The dough composition according to claim 9, wherein said hemicellulase is a pentosanase.

11. The dough composition according to claim 10, wherein said pentosanase is a xylanase.

12. The dough composition according to claim 8, wherein said oxidase is selected among an aldose oxidase, a glucose oxidase, a pyranose oxidase, a lipoxygenase and an L-amino acid oxidase.

13. The dough composition according to claim 1, wherein the effective amount of the enzyme(s) is about 0.01 mg to about 100 mg per kilogram of flour.

14. The dough composition according to claim 13, wherein the effective amount of the enzyme(s) is about 0.1 mg to about 25 mg per kilogram of flour.

15. The dough composition according to claim 14, wherein the effective amount of the enzyme(s) is about 0.1 mg to about 5 mg per kilogram of flour.

16. The dough composition according to any of claims 1-15, wherein said lipid-encapsulated or lipid-coated enzyme(s) is/are in particle form, at least 95% by weight of said particles having a particle size in the range 10-200 μm.

17. The dough composition according to claim 16, wherein at least 95% by weight of said particles have a particle size in the range 20-150 μm.

18. The dough composition according to any of claims 1-17, wherein said lipid-encapsulated or lipid-coated enzyme(s) is/are provided in the form of vesicles.

19. The dough composition according to claim 18, wherein said vesicles are of a multi-lamellar bilayer structure.

20. The dough composition according to claim 18, wherein said vesicles are comprised of one or more lipid substances comprising a phosphoglyceride.

21. The dough composition according to claim 20, wherein said phosphoglyceride is selected among phosphatidylethanolamine (PE) and phosphatidylcholine (PC) and derivatives thereof.

22. The dough composition according to claim 21, wherein said phosphoglyceride is selected among egg phosphatidylethanolamine, transesterified phosphatidylethanolamine, N-ethyl-di-oleoyl phosphatidylethanolamine and dimyristoyl hosphaphosphatidylcholine.

23. The dough composition according to any of claims 20-22, wherein said phosphoglyceride is used in admixture with one or more components selected among saturated or mono- or polyunsaturated, linear or branched C6-C22 fatty acids and edible, amphiphilic polymers, preferably of sugar or cellulose origin.

24. The dough composition according to claim 23, wherein said fatty acid is a saturated or mono- or polyunsaturated, linear or branched C12-C22 fatty acid.

25. The dough composition according to any of claims 1-17, wherein said one or more enzyme(s) encapsulated or coated with a lipid substance is/are provided in the form of solid particles comprising an enzyme-containing core and a coating of a lipid substance.

26. The dough composition according to claim 25, wherein said lipid substance comprises a material selected among glycerol esters, phosphoglycerides, waxes, fatty acids, fatty acid alcohols, paraffins and mixtures thereof.

27. The dough composition according to claim 1, wherein the flour is obtained from one or more ingredients selected from the group consisting of wheat meal, wheat flour, corn meal, corn flour, durum flour, rye meal, rye flour, oat meal, oat flour, soy meal, soy flour, sorghum meal, sorghum flour, potato meal, and potato flour.

28. A method for preparing a dough composition according to any of claims 1-24, comprising addition of one or more enzyme(s) encapsulated or coated by a lipid substance, wherein said lipid substance
(a) inhibits release of said enzyme(s) to the surrounding dough at a temperature of less than 25° C., and
(b) undergoes a phase transition in the temperature range from 25° C. to 60° C. allowing release of said enzyme(s) to a dough mixture comprising flour.

29. The method of claim 28, wherein the enzyme(s) is in the form of enzyme containing vesicles prepared by:
(i) mixing a buffered enzyme containing liquid with a lipid substance to produce a dispersion,
(ii) forming at least one lipid bilayer around enzyme by repeatedly cooling and heating under agitation the dispersion,
(iii) adding a dispersion of the enzyme containing vesicles obtained in step (i) and (ii) to a dough mixture comprising flour.

30. The method of claim 28 wherein the enzyme(s) is in the form of solid enzyme particles coated with a lipid substance prepared by:
(i) providing an enzyme-containing core by:
a) spray drying an enzyme-containing liquid,
b) adding an enzyme-containing liquid to a dry powder composition of conventional granulation components in a mixer,
c) extruding an enzyme-containing paste,
d) layering an enzyme around a hydratable core particle, or
e) prilling an enzyme-containing molten wax,
(ii) coating said enzyme-containing core with said lipid substance to obtain enzyme granules, and
(iii) adding said coated enzyme particles to a dough mixture comprising flour.

31. A use of one or more lipid-encapsulated or lipid-coated enzyme(s) in a dough composition, wherein said lipid substance undergoes a phase transition in the temperature range from 25° C. to 60° C.

32. A method for improving one or more properties of a dough, comprising adding one or more lipid-encapsulated or lipid-coated enzyme(s) to a dough mixture wherein said lipid substance undergoes a phase transition within a temperature range from 25-6020 C., before baking to obtain a baked product.

33. The method according to claim 32, wherein the dough is fresh or frozen.

34. The method according to any of claims 32-33, further comprising incorporating one or more additional enzymes selected from the group consisting of a cellulase, a cyclodextrin glucanotransferase, a glycosyltransferase, a laccase, a peptidase, a peroxidase, a phospholipase, and a protein disulfide isomerase.

35. The method of any of claims 32-34, further comprising incorporating one or more additives selected from the group consisting of a protein, an emulsifier, a granulated fat, an oxidant, an amino acid, a sugar, a salt, a flour, and a starch.

36. A method for preparing a baked product, comprising baking a dough produced by the method of any of claims 32-35 to produce a baked product.

36. A dough product obtained from a dough prepared by the method of claims 31-34.

37. A baked product produced by the method of claim 36, wherein said product is selected from the group consisting of a bread, a roll, a French baguette-type bread, a pasta, a pita bread, a tortilla, a taco, a cake, a pancake, a biscuit, a cookie, a pie crust, steamed bread, and a crisp bread.
